(19) United States
(12) Patent Application Publication
(10) Pub. No.: US 2019/0119971 A1
(43) Pub. Date: Apr. 25, 2019

(54) OPPOSING DOOR OPENER

(71) Applicant: John H. Staehlin, Westminster, MD (US)

(72) Inventor: John H. Staehlin, Westminster, MD (US)

(21) Appl. No.: 15/787,851

(22) Filed: Oct. 19, 2017

(51) Int. Cl. E05F 17/00; E05C 19/16; E05F 15/63

(52) U.S. Cl. CPC E05F 17/002; E05C 19/166; E05F 15/63; E05F 2015/631; E05F 2017/008; E05Y 2900/136; E05Y 2900/132

(57) ABSTRACT

A track-guided power door operator used to simultaneously open a set of opposing hinged doors is disclosed. The door operator comprises a pair of articulated arm linkages, each pair of which is pivotally mounted at One end to a vertically oriented pivot pin at one end of a guide member and pivotally connected at the other end to a vertically oriented pivot pin of a yoke member of a translating carriage, which is engaged by a horizontal lead screw. Translation of the carriage member due to rotation of the lead screw causes lateral separation between the knuckles of the articulated arm pairs to cause doors contacted by the knuckles to rotate about their respective hinges. The door operator may include a control unit to control operation of the doors. The operator may further include magnetic latches to lock the doors closed.

### TECHNICAL FIELD

The present disclosure relates to power-operated actuators of entry and exit doors of a dwelling unit where there is one main door and a secondary door, such as a screen or storm door, mounted within a single door frame. The disclosed door opener is especially designed for physically disabled and elderly occupants who require wheelchairs or walking assistance devices, allowing simultaneous operation of the main door and secondary door to facilitate traversing of the doorway by the occupant of the home.

### BACKGROUND

For a person living with a disability or for elderly individuals, especially those in wheelchairs or scooters, a double door entry to a home, such as a main door and a screen or storm door, presents a major obstacle. To exit the home, one must first move forward to open the inner door, then move backwards to fully open the inner door, move forward again to open the outer door and lock it in an open position, move backwards again to reach the inner door, move for ward past the threshold again to close the inner door, and then move further out the clear the outer door and unlock it to allow it to return to its closed position. Going back into the home presents a similar challenge, overcome through a reversed sequence of the above operations. Entering or exiting the home while carrying groceries or the like introduces additional steps in the sequence to free up one or both hands and later recollect the items before finally closing both of the doors. Known devices for holding one of the two doors in an open position, as disclosed in U.S. Pat. No. 6,910,302 to Crawford for example, are of minimal help as they still require completion of the full sequence of steps above.

Despite this difficulty, it may still be desirable for disabled individuals to keep the double door configuration in place for their home. Screen doors allow airflow into the home to efficiently regulate temperature while keeping insects and debris out. Storm doors can also protect foe main door from damage. The second door may further add an extra level of security, discouraging intruders by providing an additional barrier to entry. Homeowner associations or other regulations may also prohibit removal of the second door or removal may be too cumbersome for the disabled individual.

One possible solution to assist the physically disabled in traversing the double door entryway of their home includes an automated door actuator that can move a hinged door between its closed and open positions. One example of an automated door opener is disclosed in U.S. Pat. No. 5,507,120 to Current, hereby incorporated by reference. Such openers typically utilize a rotary drive screw to power an arm link that is pivotally attached to the door. Some door operators, such as U.S. Pat. No. 5,375,374 to Rohroff, utilize improved arm configurations to reduce the mechanical force required to open the door. The Rohroff device also discloses the use of rollers in contact with the door. There are also known door opening devices that utilize remotely controlled opening devices such as those disclosed in U.S. Pat. No. 4,658,545 to Ingham and U.S. Pat. No. 6,891,479 to Eccleston.

Automated door openers to date, however, all provide a means for actuating a single door. For double door configurations where a main door and a secondary door are installed within the same doorway, due to space limitations, it would be difficult or impossible to install a second door operator within the same doorway. In light of the foregoing, there is a need for an improved door actuator that allows for simultaneous operation of a set of opposing doors, addressing the needs of the physically disabled or elderly.

The present disclosure is directed to overcoming one or more of the problems set forth above and/or other problems of the prior art.

### SUMMARY

A door operating system for simultaneously opening a pair of opposing hinged doors comprises an external guide housing mounted to the door frame between the pair of opposing doors. Disposed within the housing is a lead screw oriented horizontally along the length of the guide housing. A pair of articulated arm linkages are included, each arm pivotally connected on one end to a yoke located near the mounting end of the guide housing and pivotally connected on the other end to a carriage member. Bach linkage comprises two arm members pivotally connected to each other. Preferably, the two arm members are connected by a knuckle roller, each roller making contact with one of the doors.

A drive is included to induce rotational movement of the screw. The carriage member is internally threaded to engage the lead screw, whereby rotation of the screw causes linear translation of the carriage member. As a result, the obtuse angle between the two members of each arm linkages is decreased, thereby causing each arm linkage to apply pressure to the surface of one of the two doors forcing it to pivot about its hinges.

### BRIEF DESCRIPTION OF THE DRAWINGS

FIG. 1 is an isometric view of the opposing door opening system.

FIG. 2 is an isometric view of the opposing door opening system with the external guide tube housing removed to show the internal components of the system.

FIG. 3 is an end view of the opposing door opening system along the axis of the drive when the doors are in a closed position.

FIG. 4 is an isometric view of the electrical control unit.

FIG. 4a is an exemplary control device for activating the electrical control unit when opening the door.

FIG. 4b is an exemplary lock box housing a switch to disable the electromagnetic locks and allow entry in the event of an emergency.

### DETAILED DESCRIPTION

Reference will now be made in detail to the present embodiments, examples of which are illustrated in the accompanying drawings. Whenever possible, the same reference numbers will be used throughout the drawings to refer to the same or like parts.

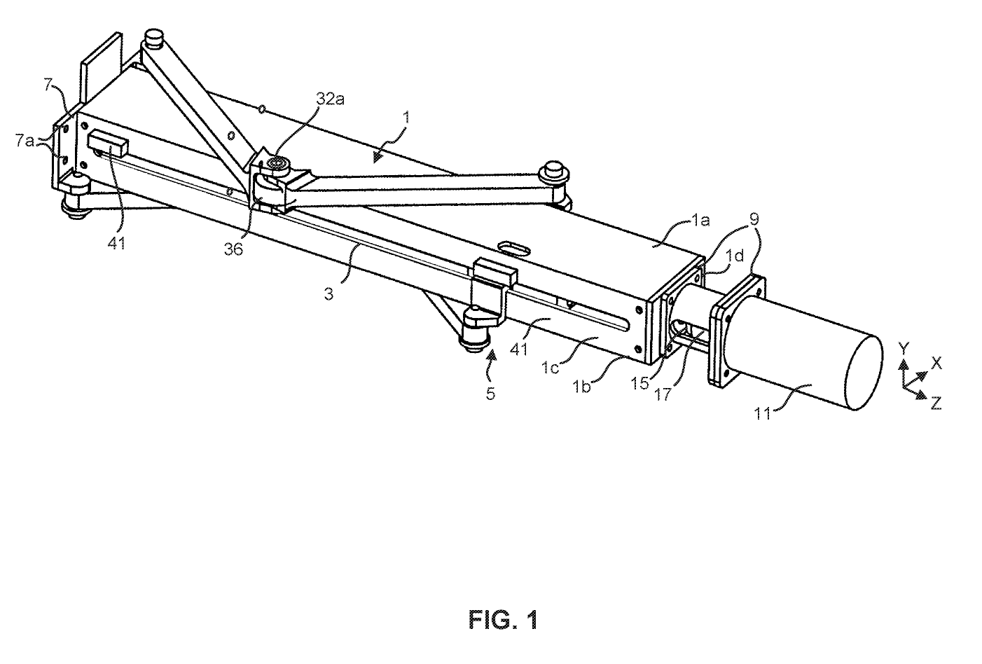

FIG. 1 depicts an exemplary door opener system. The system as shown in FIG. 1 is ready to be mounted to the upper interior of the door frame so that the guide housing 1 is oriented horizontally between the two closed doors. The guide housing 1 is a rectangular tube comprising a top wall 1a, a bottom wall 1b and two side walls. Each side wall may feature a guide track cutout 3 to guide the carriage assembly 5 along the length of the guide housing 1. The carriage assembly may also be guided by other sufficient means (e.g., rollers or low friction buttons). The guide housing 1 is closed on each end by lead screw bearing blocks 7 and 9. In the embodiment shown, bearing block 7 comprises mounting holes 7a for mounting the opener to the door frame. The opener system may be mounted to the frame in other suitable manners or locations to fit within the frame. A drive, shown generally at 11, is included and mounted to the motor-end bearing block 9.

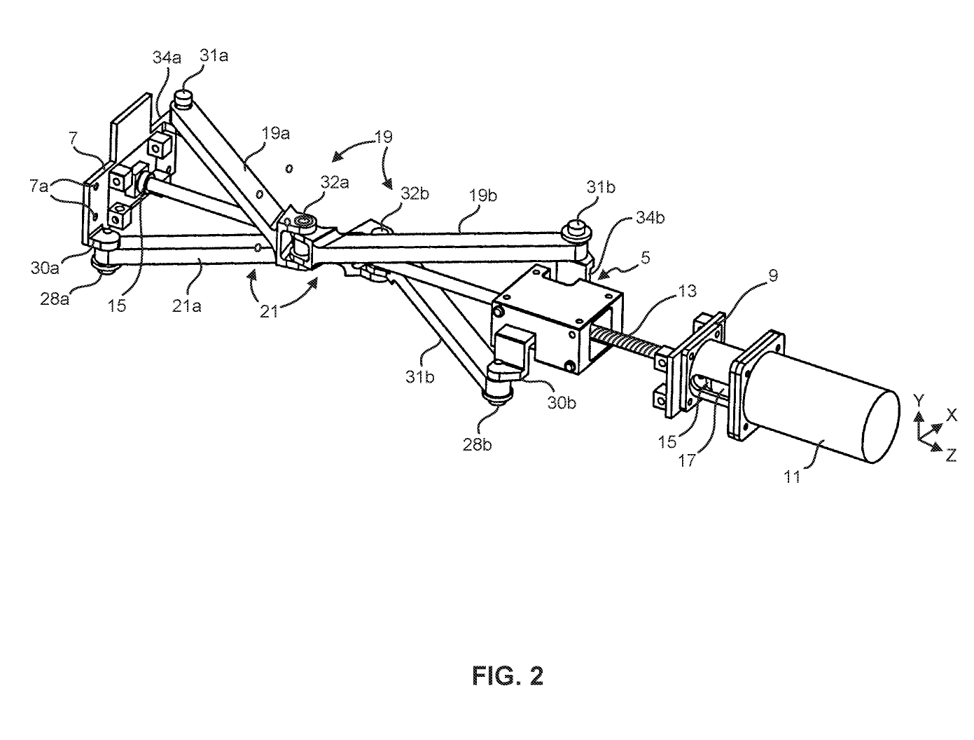

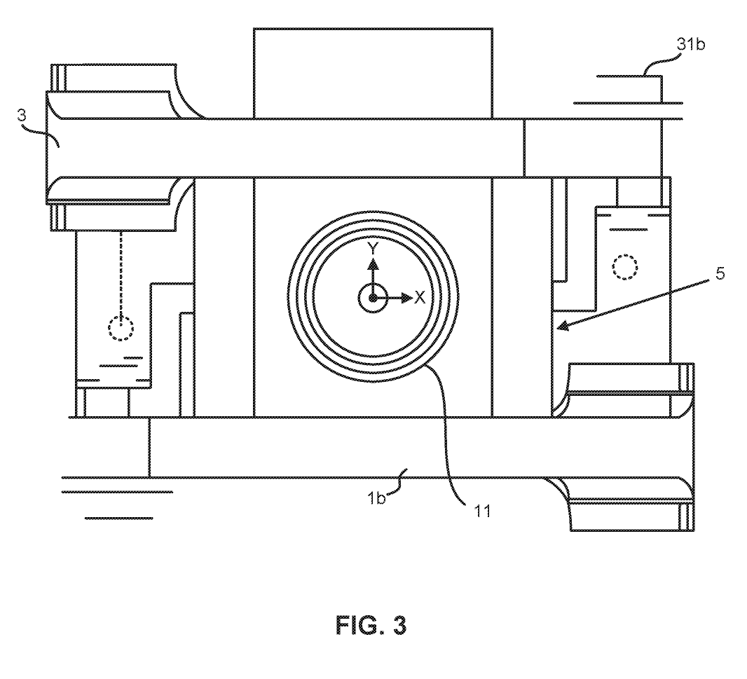

FIG. 2 depicts the opposing door opener with the guide housing 1 removed to show the internal components of the system. FIG. 3 depicts an end view of the opposing door opener along the axis of the drive 11 when the doors are in a closed position. The door opener includes a threaded lead screw 13 mounted along the center of the guide housing 1. The lead screw 13 is supported on each end by bearings 15, which are contained within the bearing blocks 7 and 9. The drive 11 engages the lead screw 13, to allow the drive 11 to rotate the lead screw 13 about its longitudinal axis Z. A slip clutch 17 may be included to couple the drive 11 to the lead screw 13 to allow rotation of the lead screw 13 during normal operation and limit the maximum torque applied to prevent damage to the lead screw 13.

The door opener system includes a pair of articulated arm linkages 19, 21 free to move along a horizontal plane parallel to the upper door frame member. Both articulated arm linkage 3 comprises two arm members 19a, 19b and 21a, 21b connected by a vertical knuckle pin 24a, 24b. Each arm linkage 19, 21 is pivotally connected on one end to a support yoke 26 and associated pivot shoulder bolt 28 of the hearing block 7. The opposite end of each arm linkage 19, 21 is pivotally connected by a pivot shoulder bolt 28a, 28b to a translating yoke 30, integrally connected to the carriage assembly 5. The articulated arms 19, 21 are positioned to form an obtuse angle between the arm members when the doors are in a closed position. The left hand arm linkage 21a, 21b is pivotally connected to the yokes 30a, 30b by shoulder bolts 28a, 28b on the right hand side of the door opening system with the knuckle pin 32a in close proximity to the left hand side door. The second arm linkage 19a, 19b is pivotally mounted by shoulder bolts 31a, 31b to the yokes 34a and 34b on the left hand side of the door opening system with the knuckle pin 32b in close proximity to the right hand side door.

Rotation of the lead screw 13 causes the carriage assembly to translate along the longitudinal axis Z of the lead screw. As a result, the obtuse angle between the two members of the arm linkages 19, 21 is decreased, thereby applying pressure to the surface of each door forcing it to pivot about its hinges. In the preferred embodiment, knuckle pins 32a, 32b are equipped with at least one integral knuckle roller 36 pivotally rotating on the same vertical axis of the knuckle pin 32a, 32b. The knuckle roller 36 makes rolling contact with one of the two doors being operated. The door may also be equipped with a suitable known door closure device (e.g., a typical dashpot spring) to maintain door contact with the knuckle rollers 36 during opening and closing operations.

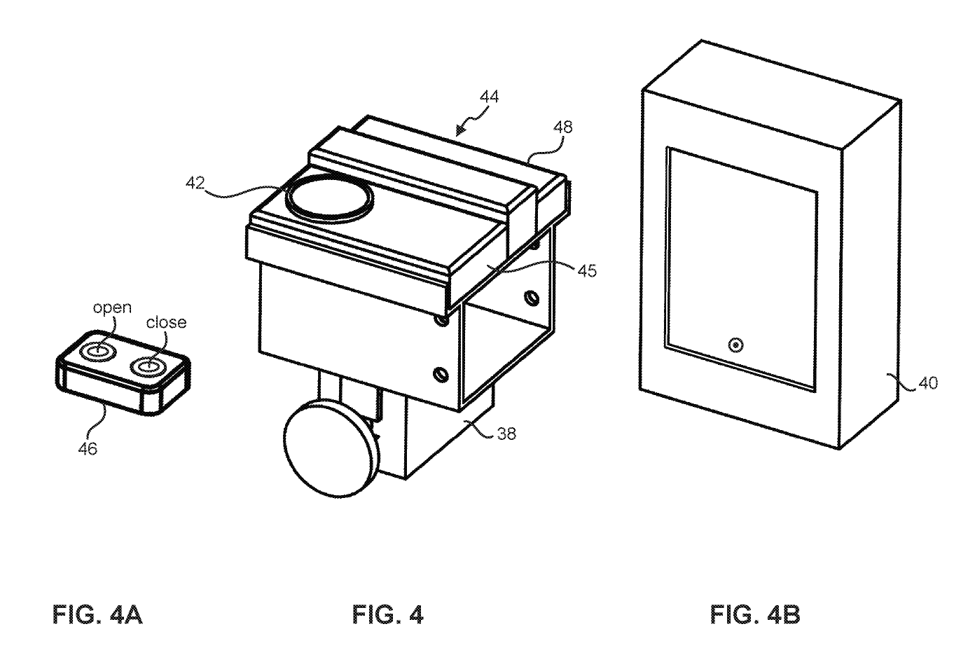

In some embodiments, the door opener system may also include a pair of electronically activated magnetic locks 38 to secure each door against the door frame (not shown) in a closed position, whereby one of the locks 38 is mounted on the door frame. The electromagnetic locks 38 are configured to release their closure force prior to beginning the opening sequence of the system. An outside lock box 40 (FIG. 4b) may be included to house a switch for disabling the electromagnetic locks 38 to allow entry in case of an emergency. An alarm 42 may also be included, triggered when the outside lock box is broken to alert occupants of the home of the entry.

As shown in FIG. 4, the door opener system of the present invention may be equipped with a control unit 44 in electrical communication with the drive 11, which extends through the control unit 44 and is secured to the motor-end bearing block adjacent to the slip-clutch 17. The control unit 44 includes a suitable microprocessor 45 for controlling the door opener system to open the door. A wireless control device 46, as shown in FIG. 4a, may provide the means for the user of the door opener system to open and close the doors. Other suitable signal devices (e.g., a wall switch plate) may alternatively be included to provide the open and close signals to the control unit 44. During operation, upon pressing the “Open” button of the control device 46, the control unit 44 cuts off power to the electromagnetic lock 38 thereby releasing contact force between the magnetic locks 38 and the door frame (not shown). The control unit 44 then applies power to the drive 11 thereby rotating the lead screw 13 to open the opposing doors. A carriage travel limit sensor 41 may be included to trigger the control unit 44 to cut power to the drive 11. Upon pressing the “Close” button of the control device 46, the control unit 44 applies power to the drive 11 in a reverse direction to return the carriage assembly 5 and roller arms 16, 21 to their original position and close the doors. The microprocessor may also be equipped with a timer to close the doors automatically after a set time delay. A battery backup unit 48 may be included to provide power to operate the doors in the event of a power failure.

It will be apparent to those skilled in the art that various modifications and variations can be made to the opposing door opener of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A swing door operating system for simultaneously opening a set of opposing hinged doors connected to a door frame, the system comprising:
a central guide tube mounted on the door frame and aligned horizontally between the set of opposing doors;
a lead screw disposed within the guide tube for translating rotational motion into linear motion,
a drive for powering the rotation of the lead screw about the horizontal axis of the central guide tube;
a carriage member for engaging the lead screw, the carriage member being translated linearly along the horizontal axis of the guide lube upon rotational movement of the screw; and
a pair of articulated arm linkages, each pair of the linkages being pivotally connected at one end to the carriage member and being pivotally connected at the other end to a fixed pivot point on one end of said guide tube, whereby translation of the carriage member causes lateral separation, between the knuckles of the articulated arm pairs to cause doors contacted by the knuckles to rotate about their respective hinges.

2. The door operating system of claim 1, wherein the knuckles of the articulated arms have integral rollers pivotally mounted on the rotational axis of the knuckle to provide rolling engagement with the doors.

3. The door operating system of claim 1, wherein the translating carriage rides along the interior of the guide housing on a set of rollers.

4. The door operating system of claim 1, wherein the translating carriage rides along the interior of the guide housing on a set of low friction buttons.

5. The door operating system of claim 1, wherein said lead screw is supported by a pair of spaced-apart bearings which are mounted on the interior of the guide tube.

6. The door operating system of claim 1, also including a pair of magnetic locks for securing each door against the door frame.

7. The door operating system of claim 14, wherein said inline switch energizes a separate set of contacts to sound an alarm altering occupants of emergency entry.

8. The door operating system of claim 1, also including a pair of limit switches adjustably mounted to the guide housing to limit linear travel of the carriage.

9. The door operating system of claim 1, also including a slip clutch coupling the lead screw and the drive for limiting the maximum torque applied to the lead screw.

10. The door operating system of claim 1, also including a control unit and at least one sensor configured to generate a signal, wherein the control unit is configured to control the drive to control rotation of the lead screw based on the signal.

11. The door operating system of claim 10, wherein the at least one sensor includes a travel limit sensor and the control unit is configured to cut power to the drive based on a signal from the sensor.

12. The door operating system of claim 10, comprising of a wireless remote capable of sending open and close signals and the control unit is configured to power the drive based on input from the remote.

13. The door operating system of claim 12, also including a pair of magnetic locks for securing each door against the door frame and the control unit is configured interrupt power to the electromagnetic latches thereby releasing the restraining force on the doors.

14. The door operating system of claim 13 wherein said means for interrupting the power to the latches comprises an inline switch which when pressed, interrupts the power to the electromagnetic latches.

15. The door operating system of claim 1, wherein said drive is mounted at one end of the guide tube.

16. The door operating system of claim 1, wherein said drive is reversible for causing the power door operator to close the opposing doors.

17. A door operating system for simultaneously opening a pair of opposing hinged doors, the system comprising:
a lead screw disposed within a central housing for translating rotational motion into linear motion;
a carriage member threaded to engage the lead screw, the carriage member being translated linearly along the horizontal axis of the lead screw upon rotational movement of the screw;
a pair of rollers, each roller making rolling contact with one door
a pair of articulated arm linkages, each pair of the linkages comprising two members pivotally connected to each caner by one of the rollers, the first member being pivotally connected at one end to a fixed pivot point and the second member being pivotally connected at the other end to the carriage member, whereby linear translation of the carriage member causes lateral separation between the rollers to cause doors contacted by the rollers to rotate about their respective hinges.
